(19) United States
(12) Patent Application Publication
(10) Pub. No.: US 2008/0274256 A1
(43) Pub. Date: Nov. 6, 2008

(54) Method For Preparing a Fried Pulse-Containing Snack

(76) Inventor: Shreyas H. Ajmera, Maple (CA)

Correspondence Address: BERESKIN AND PARR, 40 KING STREET WEST, BOX 401, TORONTO, ON, M5H 3Y2, CA

(21) Appl. No.: 11/916,071

(22) PCT Filed: Jun. 1, 2006
(86) PCT No.: PCT/CA2006/000875

§ 371 Date: Nov. 30, 2007

Related U.S. Application Data
(60) Provisional application No. 60/685,773, filed on Jun. 1, 2005.

(51) Int. Cl. A23L 1/20

(52) U.S. Cl. 426/557

(57) ABSTRACT

A method for preparing a pulse-containing snack and the pulse-containing snack produced by the method. Uncooked dried pulses are soaked in an aqueous solution. The uncooked soaked pulses are then mixed with snack dough and fried. The resulting snack has a definable, intact pulse within the snack.

### FIELD OF THE INVENTION

The present invention relates to a method for adding pulses to fried snacks and fried pulse-containing snacks. In particular, the invention relates to a method that prevents disintegration of legume starches during the frying step leaving holes in the finished food product.

### BACKGROUND OF THE INVENTION

Pulses are edible leguminous seeds, such as peas, beans, lentils etc. which have long been recognized as an important and inexpensive component of the human diet, providing a rich, low-fat source of protein, complex carbohydrates and dietary fibre.

Common snack food choices include potato chips, corn chips, etc., which contain high levels of fat and calories. These snack foods are very popular and it would be beneficial to provide more nutritional value in these types of snacks.

In particular, a healthy lifestyle requires changing straight link carbohydrates to complex carbohydrates, adding fibers, increasing protein and at the same time reducing carbohydrates and calories. The addition of pulses to fried snacks has been the subject of much investigation in the food industry in order to provide a more healthy snack. Traditionally pulses have been incorporated in chips either from a dry bean powder, or from canned or dried rehydrated or freeze dried or soaked and boiled pulses.

Prior efforts to make fried food products with added pulses have resulted in a dispersion of the bean starch during the frying process. With legume powder processes, many tiny holes are left in the final fried food product. With canned or dry rehydrated or soaked and boiled or freeze dried processes, the outer lining of the legume remains within the chip but the rest disperses in the oil and leaves a hole in the chip.

For example, U.S. Pat. No. 4,124,727 discloses food products prepared from legume seeds that are soak, cooked, mashed, combined with methionine-containing ingredients and made into dough and fried in oil. However, cooking the soaked pulse before mixing it with a snack dough results in the disintegration of the pulse during frying.

Therefore, there is a need in the art for a method for preparing snacks with pulses added to it that remain a definable pulse during frying.

### SUMMARY OF THE INVENTION

The present invention relates to a process to add pulses into the dough mix of a snack product, such as corn chips, flour chips, potato chips, rice chips, grain chips, cookies or any fried snack. The method maintains the integrity of the pulse in the final fried food product.

Accordingly, in one embodiment, the invention provides a method for preparing a fried pulse-containing snack comprising the steps of:

(a) soaking dried pulses in an aqueous solution;

(b) mixing the uncooked soaked pulses with snack dough; and

(c) frying the dough-pulse mixture of step (b).

In another embodiment, the invention provides the fried pulse-containing snack produced by the methods of the invention.

Other features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### DETAILED DESCRIPTION OF THE INVENTION

As previously mentioned, the present invention provides a method for preparing fried snacks with definable pulses or crushed, diced or chopped pulses present or incorporated in fried snacks. Accordingly, the present invention provides a method for preparing pulse snacks, comprising the steps of: (a) soaking uncooked dried pulses in an aqueous solution; (b) mixing the uncooked soaked pulses with snack dough; and (c) frying the dough-pulse mixture of step b). The resulting fried snack product is optionally then packaged for future consumption.

The snack can be any snack product that is fried, preferably a starch containing a snack product. In one aspect, the snack is selected from the group consisting of corn chips, flour chips, potato chips, rice chips, grain chips, cookies or any other fried snack known in the art. In a particular aspect, a snack product made with grain may include wheat chips or wheat thins.

A wide range of pulses may be used in the method of the invention, including all edible beans, peas and lentils. Suitable beans include: members of the genus Phaseolus, including the large white, small white, pinto, red kidney, lima, adzuki, peyin, scarlet runners etc.; members of the genus Vicia, including broad beans; members of the genus Vigna, including blackeye, Cuba, and Catiang; and members of the genus Soja including soybeans. Peas include members of the genus Pisum, including smooth and wrinkled peas and yellow and green peas; and the genus Cicer, including garbanzo or chick peas. Lentils include members of the genus Lens. Preferably, the pulses are dried beans or peas or lentils.

In the method of the invention, the pulses are subject to a preliminary soak or immersion in an aqueous solution, preferably water or sodium bicarbonate solution to initiate the influx of water into the pulses, to cause the swelling of pulse tissue and to facilitate extraction of undesirable components. Accordingly, in another aspect of the invention, the aqueous solution used in step a) is water or sodium bicarbonate.

The addition of sodium bicarbonate allows a form of chemical leavening, in which an acid contained in the pulse reacts with the soda. This produces carbon dioxide upon frying resulting a fried pulse that has a lighter texture and is more palatable.

In one aspect, the total moisture content of the pulses in step a) increases to about from 40 to 60%. In a particular aspect, the total moisture content of the pulses increases to about from 45 to 55%. The moisture content of different types of pulses will vary depending on factors such as the growing location, harvest conditions, variety of pulse and storage conditions. The resulting moisture content of the pulses in the soaking stage can be readily determined by a person skilled in the art using recognized techniques. For example, a Mettler Moisture Meter can be used. In one particular method, 10 g of soaked black beans are placed in the drying plate and the moisture meter switched on. At the end of the cycle, the moisture content is taken is taken from the reading on the meter.

In another aspect, the water temperature during the soak step is room temperature or from about 5 to 70° C. In a particular aspect, the water temperature during the soak step is from about 30 to 50° C.

The amount of time required for the soak step is dependent on factors such as the temperature of the water, the type and variety of pulse, the age of the pulse, storage conditions and the like. A person skilled in the art would readily be able to select a soaking time. In a particular aspect, pulses are soaked for about 3 to 20 hours. In another particular aspect, the pulses are soaked for about 8 to 16 hours. After soaking the pulses are optionally drained in water to remove any undesirable components.

After the soak step, the method optionally includes a step of processing the pulses in order to maintain character as required by the snack. The phrase “maintain character as required by the snack” as used herein means producing a final food product that is similar in appearance and texture as the snack produced without the addition of the pulses. The processing of the pulses is by flattening, crushing, dicing or chopping. Flattening is accomplished by passing the pulses through rollers or by pressing with flat pressure plates.

The soaked pulses, processed or non-processed, are then mixed with a mixer or spread over a sheet of dough and are optionally passed through another set of rollers or presses so that the pulses take the desired thickness as required by the snack. The pulse-dough mixture is then fried producing a final fried snack that is intact. In one aspect, the frying time is from 10 to 60 seconds. The final fried snack produced by the method of the invention does not have the starch decomposed in the snack and therefore does not show holes in the final finished product.

The pulses may be flavoured at any step with a range of conventional additives and seasonings such as flavoring, seasoning, herbs, spices, salt or the like. In a particular aspect, the flavouring used in the food composition is any desirable flavouring including, but not limited to, garlic, savoury, herbs, potato flavour, sweet & sour sauce and cheese flavours, raspberry, strawberry and orange. In another particular aspect, the flavouring used in the composition is selected from the group consisting of sour cream & onion, ketchup, salt & vinegar, barbeque, Mexican taco seasoning, miso flavoring and Indian curry.

In another embodiment, the invention provides the fried pulse-containing snack produced by the methods of the invention. In one aspect, the snack has a definable pulse within the snack. In another aspect, the fried pulse-containing snack is intact. The term “intact” as used herein means that the snack does not have any holes due to the decomposition of starch.

The following non-limiting examples are illustrative of the present invention:

### EXAMPLES

### Example 1

45.36 kg of dried Black Beans with a moisture content of 11.8% were soaked in water for 8 to 12 hrs. After soaking, 68.04 kg of drained beans with a moisture content of 41.12% were recovered. The beans were put through a press with flat platform on bottom and a moving plate on the top. 60 psi pressure was applied. The psi varies on the flatness desired of the Bean and how fast one wants to run the production. The flat beans were added to 360 kg of masa flour (cooked corn flour with lime) and mixed in a paddle mixer where the mixing of the flour and the blending of the beans was performed. The mix was sheeted by Roller sheeters and cut by rotary die cutters to form chips or by cylindrical cutters. The chips were then fried in a belt type continuous fryer for 45 seconds at 350 deg F. to form a crunchy bean snack.

### Example 2

Potato or rice snacks are made by the same method as Example 1 using 360 kg of potato or rice flour.

While the present invention has been described with reference to what are presently considered to be the preferred examples, it is to be understood that the invention is not limited to the disclosed examples. To the contrary, the invention is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

1. A method for preparing a fried pulse-containing snack comprising the steps of:
(a) soaking uncooked dried pulses in an aqueous solution;
(b) mixing the uncooked soaked pulses with snack dough; and
(c) frying the dough-pulse mixture of step (b).

2. The method of claim 1 further comprising processing the pulses after step (a) to maintain character as required by the snack.

3. The method of claim 2 wherein the processing is performed by flattening or crushing or dicing or chopping the pulses.

4. The method of claim 3 wherein the flattening is performed by passing through rollers or pressing with flat pressure plates.

5. The method of claim 1, wherein the dough-pulse mixture of step (b) is flattened to a desired thickness prior to step (c).

6. The method of claim 5, wherein the flattening is performed by passing the mix through a set of rollers or presses.

7. The method of claim 1, wherein the pulses are selected from the group consisting of beans, peas and lentils.

8. The method of claim 1, wherein the snack is selected from the group consisting of corn chips, flour chips, potato chips, rice chips, grain chip and cookies.

9. The method of claim 1, wherein the pulses are soaked in the aqueous solution for about 3 to 20 hours.

10. The method of claim 1, wherein the pulses are soaked in the aqueous solution for about 8 to 16 hours.

11. The method of claim 1, wherein the pulses are soaked in step a until the total moisture content of the pulses increase to about 40 to 60%.

12. The method of claim 1, wherein the pulses are soaked in step a until the total moisture content of the pulses increase to about 45 to 55%.

13. The method of claim 1, wherein the aqueous solution is water.

14. The method of claim 1, wherein the aqueous solution is flavoured with additives or seasonings.

15. The method of claim 1, wherein the aqueous solution of step a has a temperature from 5 to 70 degrees Celsius.

16. The method of claim 1, wherein the aqueous solution of step a has a temperature from 30 to 50 degrees Celsius.

17. The method of claim 1, further comprising draining the pulses in water after step a to remove undesirable components.

18. The fried pulse-containing snack produced by the method of claim 1.

19. The fried pulse-containing snack of claim 18, wherein the pulse is definable within the snack.

20. The fried pulse-containing snack of claim 18, wherein the snack is intact.
